(19) United States
(12) Patent Application Publication
(10) Pub. No.: US 2019/0115613 A1
(43) Pub. Date: Apr. 18, 2019

(54) AQUEOUS BATTERIES WITH A MEDIATOR-ION SOLID STATE ELECTROLYTE

(71) Applicant: Board of Regents, The University of Texas System, Austin, TX (US)

(72) Inventors: Arumugam Manthiram, Austin, TX (US); Xingwen Yu, San Marcos, TX (US); Martha Gross, Austin, TX (US); Shaofei Wang, Austin, TX (US)

(21) Appl. No.: 16/219,301

(22) Filed: Dec. 13, 2018

Related U.S. Application Data
(63) Continuation of application No. PCT/US2017/037430, filed on Jun. 14, 2017.
(60) Provisional application No. 62/350,046, filed on Jun. 14, 2016.

(51) Int. Cl. H01M 10/04; H01M 10/054; H01M 10/0525; H01M 4/04

(52) U.S. Cl. CPC H01M 10/0431; H01M 10/054; H01M 4/0404; H01M 4/049; H01M 10/0525

(57) ABSTRACT

The present disclosure relates to aqueous batteries in which a mediator-ion solid state electrolyte provides ion channels through which an alkali metal ion passes during operation of the batteries, but which blocks passage of the catholyte or anolyte.

### PRIORITY CLAIM

The present application is a continuation of International Application No. PCT/US2017/037430, filed Jun. 14, 2017; which claims priority to U.S. Provisional Patent Application Ser. No. 62/350,046, filed Jun. 14, 2016, the contents of which are incorporated by reference herein in their entirety.

### STATEMENT OF GOVERNMENT INTEREST

This invention was made with government support under Grant no. DE-SC0005397 awarded by the Department of Energy. The government has certain rights in the invention.

### TECHNICAL FIELD

The present invention relates to a mediator-ion solid state electrolyte for a variety of aqueous batteries such as a zinc-bromine (Zn—Br₂) battery and a zinc-ferrocynide battery. The disclosure further provides a battery containing such an electrolyte and methods of assembling and using such as batteries.

### BACKGROUND

### Basic Principles of Batteries and Electrochemical Cells

Batteries may be divided into two principal types, primary batteries and secondary batteries. Primary batteries may be used once and are then exhausted. Secondary batteries are also often called rechargeable batteries because after use they may be connected to an electricity supply, such as a wall socket, and recharged and used again. In secondary batteries, each charge/discharge process is called a cycle. Secondary batteries eventually reach an end of their usable life, but typically only after many charge/discharge cycles.

Secondary batteries are made up of an electrochemical cell and optionally other materials, such as a casing to protect the cell and wires or other connectors to allow the battery to interface with the outside world. An electrochemical cell includes two electrodes, the positive electrode (cathode) and the negative electrode (anode), an insulator separating the electrodes so the battery does not short out, and an electrolyte that chemically connects the electrodes.

In operation, the secondary battery exchanges chemical energy and electrical energy. During discharge of the battery, electrons (e⁻), which have a negative charge (−), leave the anode and travel through outside electrical conductors, such as wires in a cell phone or computer, to the cathode. In the process of traveling through these outside electrical conductors, the electrons generate an electrical current, which provides electrical energy.

At the same time, in order to keep the electrical charge of the anode and cathode neutral, an ion having a positive charge (+) leaves the anode and enters the electrolyte and then a positive ion leaves the electrolyte and enters the cathode. The ionic charge is transferred through the electrolyte.

In order to recharge the battery, the same process happens in reverse. By supplying energy to the cell, electrons are induced to leave the cathode and join the anode. At the same time, a positive ion leaves the cathode and a positive ion joins the anode to keep the overall electrode charge neutral.

### Zn—Br₂ Batteries

Zinc (Zn) has long been considered as one of the most practical anode materials for aqueous batteries due to its low-cost, safety, reliability, and compatibility with aqueous solutions. Coupling an anode having a Zn anode active material with cathode having a liquid bromine (Br₂) cathode active material can provide a low-cost battery, as bromine (Br) is abundant. In addition, the battery may have high energy properties because Br₂ has a high electromotive force upon reduction.

Previous Zn—Br₂ flow batteries have used two electrode chambers separated by a polymer membrane, typically a microporous or ion-exchange membrane. The polymer membrane serves both as an ionic charge transfer medium and as a separator between the Zn anode and the Br2 cathode. However, membrane-based Zn—Br2 batteries suffer from two persistent problems.

First, zincate (Zn(OH)₄²⁻) is formed at the anode when the battery is discharged. Zincate is readily dissolved in the electrolyte and crosses through the membrane to the cathode. Similarly, liquid Br2 in the cathode crosses through the membrane to the anode. The crossover of these active materials to the other electrode causes the battery to self-discharge. In addition, these active materials are not utilized efficiently when they migrate to the other electrode due to concentration gradients and react with its active material.

Second, over a number of charge/discharge cycles, Zn tends to form dendrites (small tentacles of Zn metal) from the anode to the cathode. These dendrites readily penetrate the membrane, allowing movement of liquid bromine and zincate through it, and, when they reach the cathode, they short circuit the battery. One approach to overcome the Zn-dendrite issue is to intermittently regenerate the cell to prevent zinc dendrites from puncturing the separator, but such a frequent regeneration wastes of electricity.

Aqueous Batteries with Liquid or Gaseous Reactants

Aqueous batteries allow the use of liquid or gaseous reactants at the anode or cathode, or in the catholyte or anolyte. Due to their high mobility as compared to solid reactants, liquid or gaseous reactants cross to the other side of the battery, often due to concentration gradients, where they react inappropriately and render active material inaccessible or otherwise render unavailable important battery components. Current technologies do not adequately address this problem. In addition, if the battery contains a metal-based anode, dendrites form and may penetrate any barriers between the cathode side and anode side of the battery, allowing increased inappropriate movement of liquid or gaseous reactants. In addition, the dendrites may reach all the way to the cathode and short circuit the battery.

### Metal Air Batteries

Metal air batteries are rechargeable batteries with a metal anode and a cathode that reversibly reacts with oxygen in the air. A number of metal air batteries, including lithium (Li)-air batteries and zinc (Zn)-air batteries are being developed. However, various problems have hampered their commercial acceptance. For instance, Zn-air batteries, when used with common electrolytes, operate only at a low voltage of around 1 V. In addition, over a number of charge/discharge cycles, Zn tends to form dendrites (small tentacles of Zn metal) from the anode to the cathode, which short circuits the battery. Furthermore, carbonates tend to form when components of the alkaline anode electrolyte react with carbon dioxide in the air. These carbonate clog up the cathode, preventing efficient reaction and eventually decreasing the number of charge/discharge cycles for which the battery may be used. An acidic electrolyte cannot be used in a basic battery format because it reacts violently with Zn in the anode. Finally, Zn tends to be lost from the anode over time because zincate (Zn(OH)₄²⁻) formed when the battery is discharged migrates away from the anode in the electrolyte.

Fe-air batteries are generally operated under alkaline conditions with a theoretical voltage of 1.28 V based on the alkaline iron anode chemistry and alkaline oxygen cathode chemistry. Due to the anode and cathode overpotentials during cell operation, the practical voltage of alkaline Fe-air batteries is low, typically less than 1 V).

Air batteries using other metals suffer from similar problems. These problems have not been solved, despite the immense interest in low-cost, high-energy-density batteries in recent years.

### SUMMARY

The disclosure provides aqueous rechargeable batteries that include an anode including an anode active material, a cathode including a cathode active material or an air cathode, an anolyte including an alkali metal ion, a catholyte including the same alkali metal ion or a metal-acid catholyte, and a mediator-ion solid state electrolyte (SSE) with ion channels through with the alkali metal ion may pass as a mediator-ion. The mediator-ion solid state electrolyte prevents at least 99.9% of direct chemical reactions between the catholyte and the anolyte or anode active material and between the anolyte and cathode.

According to more specific embodiments, each of with may be combined with the above embodiment and with one another in any combinations unless clearly mutually exclusive, i) both the anolyte and the catholyte may be aqueous; ii) the anode active material may include a metal-based active material; ii-a) the metal-based active material may include elemental metal; ii-b) the metal-based anode active material may include a metal compound; ii-c) the metal-based active material may include a metal that is not an alkali metal; ii-d) the metal-based active material may include Zn; ii-e) the metal-based active material may include iron (Fe), ii-f) the metal-based active material may include aluminum (Al) or magnesium (Mg); iii) the cathode may include a liquid cathode active material and a current collector; iv) the cathode may include a gaseous cathode active material and a current collector; v) the cathode active material may include any one or a combination of liquid bromine (Br₂), another halogen, ferrocyanide (K₄Fe(CN)₆), hydrogen peroxide, bromate, permanganate, nickel oxide, dichromate, iodate, a polysulfide and sulfur mixture, polysulfide, sulfur, manganese oxide, hypochlorite, perchlorate, copper, chlorate, manganese oxide, iron, copper, nickel oxide, perchlorate, nitrate, sodium bismuthate, tin, permanganate, chromate, tetramethoxy-p-benzoquinone, 2,6 dihydroxyanthraquinone, poly(aniline-co-m-aminophenol), polyaniline, poly(aniline-co-o-aminophenol), indigo carmine, indigo carmine, aminophenol, Ru-bipy, Ru-phen, Fe-bipy, Fe-phen, Ferroin, N-Phenylanthranilic acid, N-Ethoxychrysoidine, o-Dianisidine, Sodium diphenylamine sulfonate, Diphenylbenzidine, Diphenylamine, Viologen, Sodium 2,6-Dibromophenol-indophenol, Sodium o-Cresol indophenol, Thionine, Methylene blue, Indigotetrasulfonic acid, Indigotrisulfonic acid, Indigomono, Phenosafranin, Safranin T, Neutral red, ferrate, cuprous cyanide, metallocyanide, metal hydride, quinone, or an oxygen/air cathode with an acid or base electrolyte; vi) the cathode may be an air cathode including an oxygen evolution reaction (OER) material and an oxygen reduction reaction (ORR) material; vi-i) the air cathode may further include an acidic catholyte; vii) the anolyte may include a hydroxide of the alkali metal ion; viii) the catholyte may include a hydroxide of the alkali metal ion; ix) the catholyte may include a compound of the cathode active material and the alkali metal ion; x) the catholyte may include a metal acid catholyte; x-i) the metal in the metal acid catholyte may be cesium (Ce); x-ii) the acid in the metal acid catholyte may include methane sulfonic acid (MSA); xi) the alkali metal ion may be sodium ion (Na⁺) and the mediator-ion solid state electrolyte may be a Na⁺ solid state electrolyte; xi-i) the Na⁺ solid state electrolyte may be Na_{3.4}Sc₂(PO₄)_{2.6}(SiO₄)_{0.4} (NSP); xi-ii) the Na⁺ solid state electrolyte may be Na₃Zr₂Si₂PO₁₂ (NZSP); xi) the alkali metal ion may be lithium ion (Li⁺) and the mediator-ion solid state electrolyte may be a Li⁺ solid state electrolyte; xiii-i) the Li⁺ solid state electrolyte may be Li_{1+x+y}AlₓTi₂₋ₓP_{3-y}Si_{y}O₁₂ (LATP); xiv) the mediator-ion solid state electrolyte may prevents all direct chemical reactions between the catholyte and the anolyte or anode active material and between the anolyte and cathode; xv) the mediator-ion solid state electrolyte may have an ionic conductivity for the mediator-ion of at least 0.5×10⁻⁴ S/cm; xvi) the mediator-ion solid state electrolyte may have an ionic conductivity for the mediator-ion of at least 3×10⁻⁴ S/cm; xvii) the battery may at least 90% of the cathode active material, as calculated by comparing actual capacity to theoretical capacity; xviii) the cathode active material may be a liquid located in the catholyte, and, after discharge of the battery to 89% of its theoretical capacity, 20% or less of cathode active material may remain in the catholyte; xix) the cathode active material may be a liquid located in the catholyte, and, after discharge to a cutoff voltage of 45% of the battery's OCR, 5% or less of the cathode active material may remain in the catholyte; xx) the battery may have a substantially flat configuration and a power density of at least 10 mW/cm²; xvii) the battery may have a substantially flat configuration and a current density of at least 8 mA/cm².

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Embodiments of the present invention may be better understood through reference to the following figures in which:

FIG. 1 is a schematic diagram of an aqueous metal-halogen battery with a mediator-ion solid state electrolyte.

FIG. 2 is a schematic diagram of an aqueous Zn—Br₂ battery with a mediator-ion solid state electrolyte, wherein M provides the mediator ion and may be either sodium (Na) or lithium (Li). Chemical reactions within the battery are also shown.

FIG. 3 is a scanning electron microscope (SEM) image of a carbon paper used in a cathode.

FIG. 4A is a SEM image of an NSP solid state electrolyte. FIG. 4B is an X-ray diffraction (XRD) pattern of an NSP solid state electrolyte.

FIGS. 5A and 5B present data for a Zn(NaOH)∥Na-SSE∥Br₂ (NaBr) cell. FIG. 5A is a full discharge curve. FIG. 5B is an Ultraviolet-Visible (UV-Vis) spectra graph of undischarged catholyte and two discharged catholytes.

FIGS. 6A-6D provides data for a Zn(NaOH)∥Na-SSE∥Br₂(NaBr) cell and a Zn(NaOH)∥Li-SSE∥Br₂ (NaBr) cell. FIG. 6A is a voltage profile for a Zn(NaOH)∥Na-SSE∥Br₂ (NaBr) cell at different current densities. FIG. 6B is a voltage profile of a Zn(NaOH)∥Li-SSE∥Br₂ (NaBr) cell at different current densities. FIG. 6C is the polarization curves and power plots for a Zn(NaOH)∥Na-SSE∥Br₂ (NaBr) cell (upper portion) and a Zn(NaOH)∥Li-SSE∥Br₂ (NaBr) cell (lower portion). FIG. 6D is the Nyquist plots of electrochemical impedance spectroscopies (EIS) of both cells.

FIG. 7A provides polarization behavior data for a Zn(NaOH)∥Na-SSE∥ferrocyanide battery. FIG. 7B provides polarization behavior data for a Zn(NaOH)∥Li-SSE∥ferrocyanide battery.

FIG. 8 is a schematic diagram of an Fe-ferrocyanide battery with a mediator-ion solid state electrolyte. Chemical reactions within the battery are also shown.

FIG. 9 is a voltage profile of a Zn(NaOH)∥Na-SSE∥K₃Fe(CN)₆(NaOH) cell at different current densities.

FIG. 10 is a schematic diagram of a Fe-air battery with a mediator-ion solid state electrolyte. Chemical reactions within the battery are also shown.

FIG. 11 is X-ray diffraction (XRD) data for components of an Fe-air battery. The top panel shows XRD data for iron oxide (Fe₂O₃) supported on carbon nanofiber (CNF). The middle panel shows XRD data for the CNF alone. The bottom panel shows XRD data for iron oxide alone.

FIG. 12 is an SEM image of iron oxide supported on CNF.

FIG. 13A is a Fe 2p X-ray photoelectron spectrum for iron oxide on CNF.

FIG. 13B is a Fe 3p X-ray photoelectron spectrum for iron oxide on CNF.

FIG. 14 is a cyclic voltammogram of an iron oxide on CNF electrode in a 0.5 M NaOH solution at a scan rate of 10 mV/s.

FIG. 15 is a voltage profile during electrodeposition of iridium oxide (IrO₂) on titanium (Ti) mesh to form an OER.

FIG. 16 is set of polarization curves of different OERs in a 0.1 M H₃PO₄+1 M NaH₂PO₄ metal-acid catholyte at a scan rate of 1 mV/s.

FIG. 17 is a chronopotentiometry profile of an IrO₂/Ti OER at a current density of 1.0 mA/cm² in a 0.1M H₃PO₄+1 M NaH₂PO₄ metal-acid catholyte.

FIG. 18 is a first charge profile of a Fe(NaOH)∥Na-SSE∥O₂(H₃PO₄/NaH₂PO₄) battery.

FIGS. 19A and 19B present voltage profile data of Fe-air batteries. FIG. 19A is a voltage profile of a Fe(NaOH)∥Na-SSE∥O₂(H₃PO₄/NaH₂PO₄) battery at different current densities. FIG. 19B is a voltage profile of a Fe(LiOH)∥Li-SSE∥O₂(H₃PO₄/LiH₂PO₄) battery at different current densities.

FIG. 20 is a Nyquist plot of the electrochemical impedance spectroscopy (EIS) data of a Fe(NaOH)∥Na-SSE∥O₂(H₃PO₄/NaH₂PO₄) battery and a Fe(LiOH)∥Li-SSE∥O₂(H₃PO₄/LiH₂PO₄) battery.

FIG. 21 is a typical charge/discharge profile of a Fe(NaOH)∥Na-SSE∥O₂(H₃PO₄/NaH₂PO₄) battery at +/−1.0 mA/cm for 50 cycles.

FIG. 22 is a schematic diagram of a Zn-metal acid battery with a mediator-ion solid state electrolyte. Chemical reactions within the battery are also shown.

FIG. 23 is a voltage profile of a Zn(NaOH)∥Na-SSE∥Ce(VI)/MSA) battery at different current densities.

FIG. 24 is a graph of discharge capacity and Coulombic efficiency versus cycle number of a Zn(NaOH)∥Na-SSE∥Ce(VI)/MSA) battery.

### DETAILED DESCRIPTION

This disclosure provides an aqueous battery that uses a mediator-ion, including a mediator-ion solid state electrolyte. The mediator-ion may be present in both the catholyte and the anolyte and may pass through ion channels in the mediator-ion solid state electrolyte. In particular examples, the battery may be a rechargeable aqueous metal-halogen battery or a rechargeable aqueous metal-ferrocynide battery, both with a mediator-ion solid state electrolyte.

In general, the aqueous battery has an anode side and a cathode side, separated by the mediator-ion solid state electrolyte. An anolyte is present on the anode side of the battery and a catholyte is present on the cathode side. One or both of the anolyte or catholyte is aqueous. The anolyte and catholyte contain the mediator-ion. The mediator-ion solid state electrolyte allows the mediator-ion to pass through ion channels. It chemically isolates the anolyte and the catholyte because it does not substantially allow passage of larger chemical species that will detrimentally chemically react with other chemical species on the other side of the battery. For instance, in a zinc-anode battery, the mediator-ion solid state electrolyte does not substantially allow the passage of zincate to the cathode side of the battery. In addition, because the mediator-ion solid state electrolyte substantially chemically isolates the anolyte and the catholyte, different electrolytes may be used for both. The mediator-ion solid state electrolyte may also have sufficient mechanical integrity to substantially block most dendrites when they reach it, preventing breach of the mediator-ion solid state electrolyte by dendrites. The battery design is robust and can accommodate anode and cathode active materials in solid, liquid, and gaseous phases.

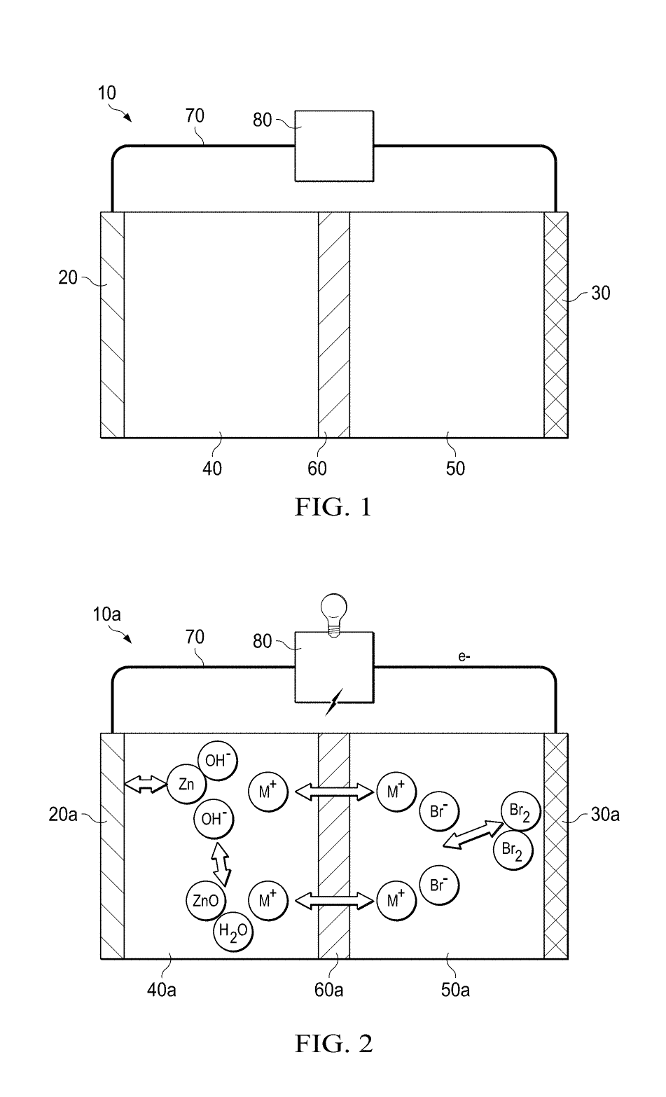

FIG. 1 is a schematic diagram of aqueous metal battery 10. Battery 10 includes an anode 20 which contains a metal-based anode active material. The metal-based anode active material may be contained in a more complex composite, such as a metal-carbon matrix, or in a metal compound, including organic compounds. Anode 20 and the anode active material may include combinations of materials. The metal anode active material may act a current collector, or a separate current collector, such as a foil, sheet, or bound layer of a different metal or a thin sheet of electrically conductive carbon, may be provided.

The metal-based anode reactive material may include solid metal that may form a metal compound upon chemical reaction with the anolyte. Zn is used as an example metal throughout this disclosure, but other metals, such as, iron (Fe), aluminum (Al), and magnesium (Mg) may also be used in place of Zn. Some examples using Fe are also provided. In some cases where the metal-based anode active material includes a metal compound, the metal compound may be dissolved or suspended in the anolyte or otherwise part of the anolyte, in which case the part of anode 20 will occupy the same portion of battery 10 as the anolyte.

Battery 10 also includes cathode 30, which contains a cathode active material or, in the case of an air battery, an oxygen evolution reaction (OER) material and an oxygen reduction reaction (ORR) material. The cathode active material may be an element or a compound, such as a halogen, particularly bromine, or ferrocyanide. The cathode active material may be present as a solid, or it may be present as a liquid or gas, which may be mixed with the catholyte. Particularly if the cathode active material is a liquid or gas, cathode 30 may include a current collector, such as metal foil or sheet or thin bound layer, or a thin sheet of electrically conductive carbon. A carbon or metal matrix may also be used as a current collector and to facilitate electrochemical reaction of a liquid or gas cathode active material. Furthermore, particularly if the cathode active material is a liquid or gas mixed with catholyte or a compound dissolved or suspended in the catholyte, part of cathode 30 will occupy the same portion of battery 10 as the catholyte.

Liquid bromine (Br₂) is used as an example cathode active material throughout this disclosure, but other cathode active materials may be used alone or in combination with themselves or liquid bromine. Suitable cathode active materials include hydrogen peroxide, bromate, permanganate, nickel oxide, dichromate, iodate, a polysulfide and sulfur mixture, polysulfide, sulfur, manganese oxide, hypochlorite, perchlorate, copper, chlorate, manganese oxide, iron, copper, nickel oxide, perchlorate, nitrate, sodium bismuthate, tin, permanganate, chromate, tetramethoxy-p-benzoquinone, 2,6 dihydroxyanthraquinone, ferrocyanide, poly(aniline-co-m-aminophenol), polyaniline, poly(aniline-co-o-aminophenol), indigo carmine, indigo carmine, aminophenol, Ru-bipy, Ru-phen, Fe-bipy, Fe-phen, Ferroin, N-Phenylanthranilic acid, N-Ethoxychrysoidine, o-Dianisidine, Sodium diphenylamine sulfonate, Diphenylbenzidine, Diphenylamine, Viologen, Sodium 2,6-Dibromophenol-indophenol, Sodium o-Cresol indophenol, Thionine, Methylene blue, Indigotetrasulfonic acid, Indigotrisulfonic acid, Indigomono, Phenosafranin, Safranin T, Neutral red, ferrate, cuprous cyanide, metallocyanide, metal hydride, and quinone. Oxygen/air cathodes with an acid or base electroltye may also be used.

If cathode 30 is an air cathode, it may be a decoupled air cathode including an ORR component and an OER component, with the ORR component and OER component physically separate, as well as an acidic catholyte

Battery 10 further includes an aqueous alkali metal ion anolyte 40. If the anode active material contains an alkali metal, then the alkali metal in the anolyte is a different alkali metal than in the anode active material.

Battery 10 also includes a catholyte 50, which may include an alkali metal ion catholyte or a metal-acid catholyte. The alkali metal ion in an alkali metal ion catholyte 50 is the same as that in anolyte 40. Battery 10 further includes mediator-ion solid state electrolyte 60, containing the same alkali metal ion as anolyte 40 and catholyte 50. Mediator-ion solid state electrolyte 60 exchanges the alkali metal ion with anolyte 40 and catholyte 50 as needed to maintain charge balance, providing ionic channels between the anode side of the battery and the cathode side of the battery. Mediator-ion solid state electrolyte 60 also substantially blocks the flow of liquid between the anode side of battery 10 and the cathode side of battery 10, but also contains ion channels that allow the mediator ion to pass through. As a result, anolyte 40 and catholyte 50 cannot directly chemically react with one another. Catholyte 50 also cannot reach and directly chemically react with the anode active material. Anolyte 40 cannot reach and directly react with the cathode active material. All, or at least 99.9% of such potential direct chemical reactions may be prevented by the mediator-ion solid state electrolyte 60 during normal operation of battery 10. Mediator-ion solid state electrolyte 60 may further prevent dendrites from reaching cathode 30. Suitable mediator-ion solid state electrolytes 60 include those containing the alkali metal ion of interest that are stable in the presence of water, such as Na₃₋₄ Sc₂(PO₄)_{2.6}(SiO₄)_{0.4} (NSP), Na₃Zr₂Si₂PO₁₂ (NZSP), Li_{1+x+y} AlₓTi₂₋ₓP_{3-y}Si_{y}O₁₂ (LATP) and other Li⁺-ion or Na⁺-ion solid state electrolytes.

Battery 10, when in use, may be connected to external circuit 70, which allows the flow of electrons between anode 20 and cathode 30. External circuit 70 may include an external device 80. External device 80 may be something powered by battery 10 if the battery is being discharged. External device 80 may be an energy source, such as an AC electricity source, if battery 10 is being charged.

FIG. 2 presents a specific aqueous metal battery, Zn—Br₂ battery 10a. M is Li or Na. Anode 20a includes metallic zinc (Zn), which may be present as metal alone or in a composite matrix with electrically conductive carbon. Cathode 30a includes liquid bromine and a current collector. Anolyte 40a includes an aqueous solution of lithium hydroxide (LiOH) or sodium hydroxide (NaOH). Catholyte 50a includes alkali metal ion bromide (MBr/MBr₂). The same alkali metal ion, either lithium ion or sodium ion, is the mediator-ion and is used in anolyte 40a, catholyte 50a, and mediator-ion solid state electrolyte 60a. The solid state electrolyte is either NSP, NZSP, or LATP.

More particularly, during discharge, zinc in the metallic zinc anode 20a is first oxidized by losing two electrons to the external circuit 70 to create a zinc cation (Zn²⁺) that reacts with negatively charged hydroxide (OHF) ions to form soluble zincate ions. The zincate has a tendency to dissociate into insoluble zinc oxide and water upon being saturated in an aqueous solution. At cathode 30a during discharge, the liquid bromine accepts an electron provided by external circuit 70 and is reduced to bromide ion (Br⁻). To maintain charge balance between the anolyte 40a and catholyte 50a, the lithium ion or sodium ion, migrates through the NSP, NZSP, or LATP solid state electrolyte 60a. Once present in catholyte 50a, the lithium ion or sodium ion reacts with bromine ion to form the alkali metal ion bromide.

During charge, zincate in anolyte 40a accepts electrons from the external circuit 70 and is reduced into metallic zinc, which plates onto anode 20a and hydroxide ions, which remain in anolyte 40a. The hydroxide ions associate with lithium ion or sodium ion in the solution and form lithium hydroxide or sodium hydroxide. The bromine ion is oxidized to liquid bromine, freeing the lithium ion or sodium ion. To maintain charge balance between the anolyte 40a and catholyte 50a, the lithium ion or sodium ion, migrates the opposite way through the NSP, NZSP, or LATP solid state electrolyte 60a.

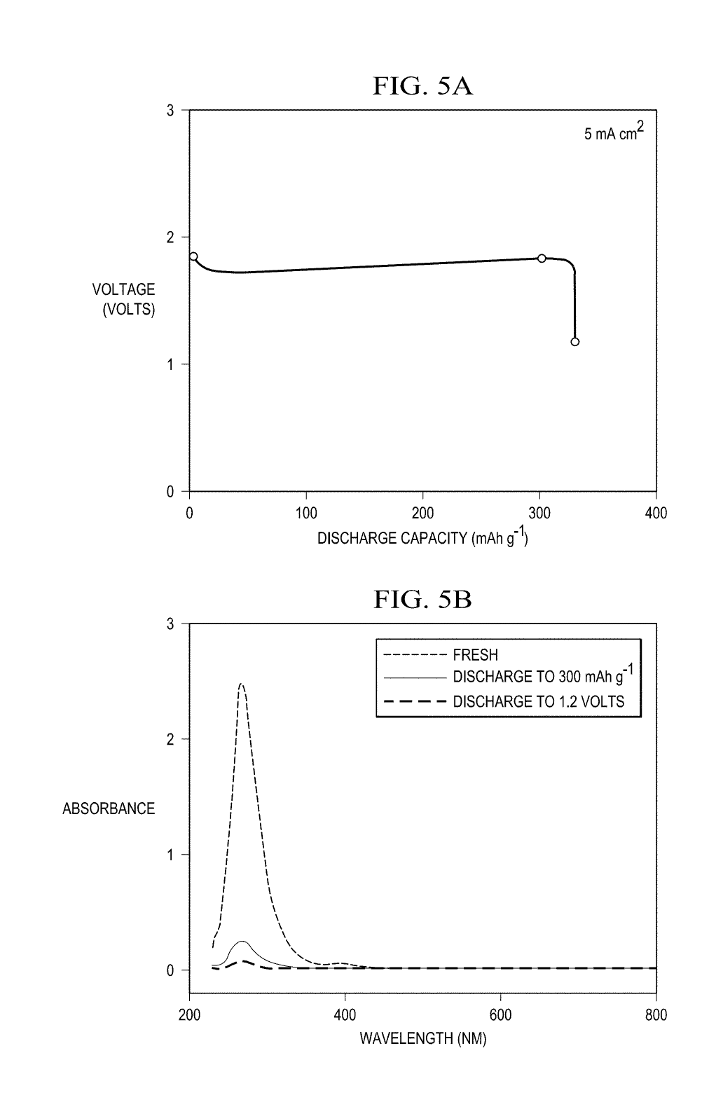

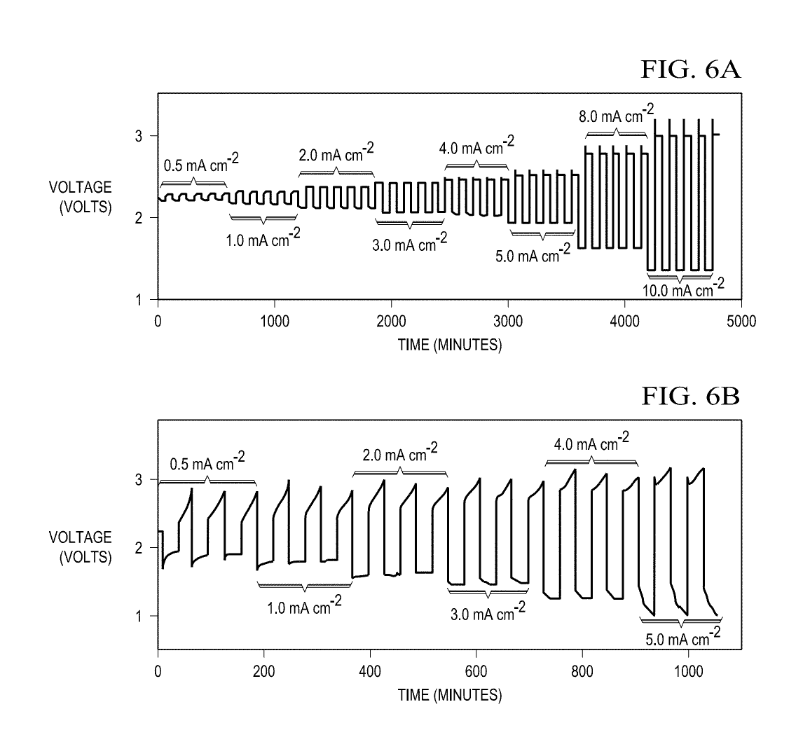

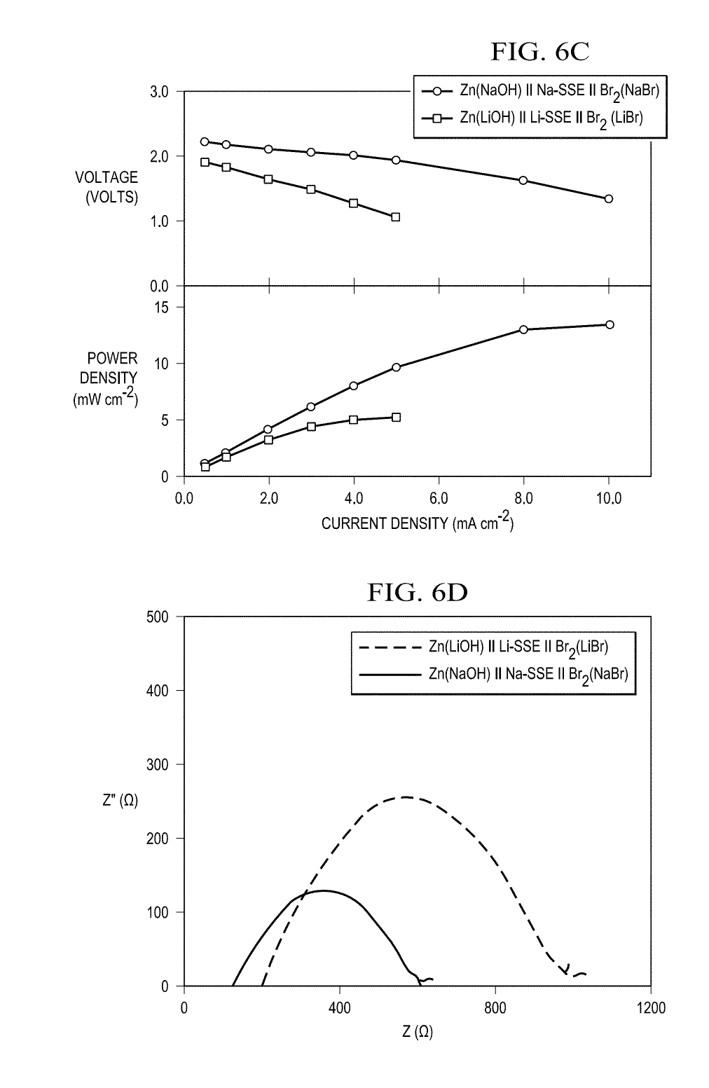

Further details of specific ZnBr₂ batteries are provided in the Example 1 and in FIGS. 5 and 6.

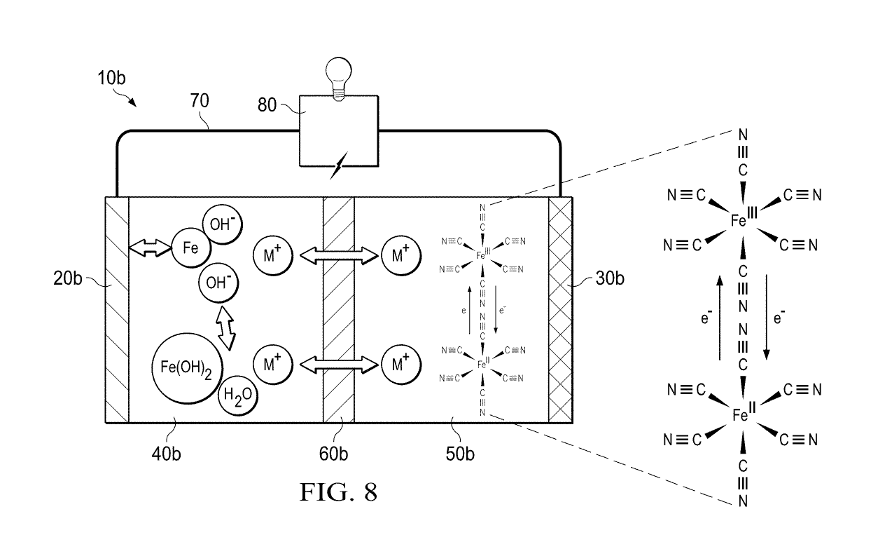

FIG. 8 presents a specific battery, aqueous Fe-ferrocyanide battery 10b. Anode 20b includes metallic iron (Fe), which may be present as metal alone or in a composite matrix with electrically conductive carbon. Cathode 30b includes a current collector. Anolyte 40b includes an aqueous solution of alkali metal hydroxide, such as lithium hydroxide (LiOH) or sodium hydroxide (NaOH). Catholyte 50b includes aqueous ferrocyanide and alkali metal hydroxide. The same alkali metal ion is the mediator-ion and is used in anolyte 40b, catholyte 50b, and mediator-ion solid state electrolyte 60b. The solid state electrolyte is either NSP, NZSP, or LATP.

More particularly, during discharge, iron in the metallic iron anode 20b is first oxidized by losing two electrons to the external circuit 70 to create an iron cation (Fe²⁺) that reacts with negatively charged hydroxide (OH⁻) ions to form soluble Fe(OH)₂. At cathode 30b during discharge, the ferrocyanide/alkali metal hydroxide catholyte 50b accepts an electron provided by external circuit 70 and the iron in the ferrocyanide is reduced from Fe³⁺ to Fe²⁺, forming ferricyanide. To maintain charge balance between the anolyte 40b and catholyte 50b, the lithium ion or sodium ion, migrates through the NSP, NZSP, or LATP solid state electrolyte 60b.

During charge, Fe(OH)₂ in anolyte 40b accepts electrons from the external circuit 70 and is reduced into metallic iron, which plates onto anode 20b and hydroxide ions, which remain in anolyte 40b. The hydroxide ions associate with lithium ion or sodium ion in the solution and form lithium hydroxide or sodium hydroxide. The ferricyanide in catholyte 50b is oxidized to ferrocyanide. To maintain charge balance between the anolyte 40b and catholyte 50b, the lithium ion or sodium ion migrates the opposite way through the NSP, NZSP, or LATP solid state electrolyte 60b.

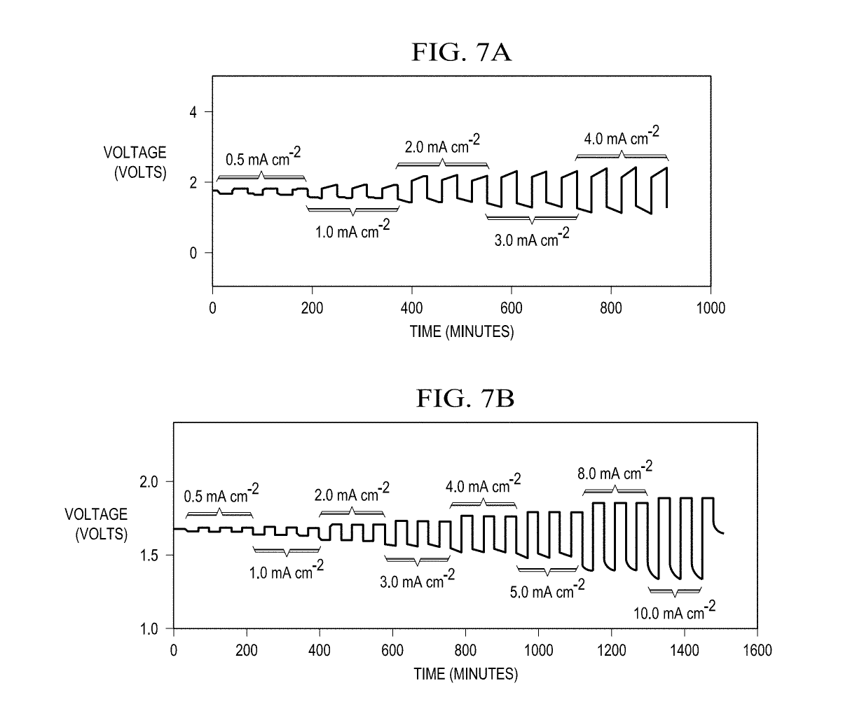

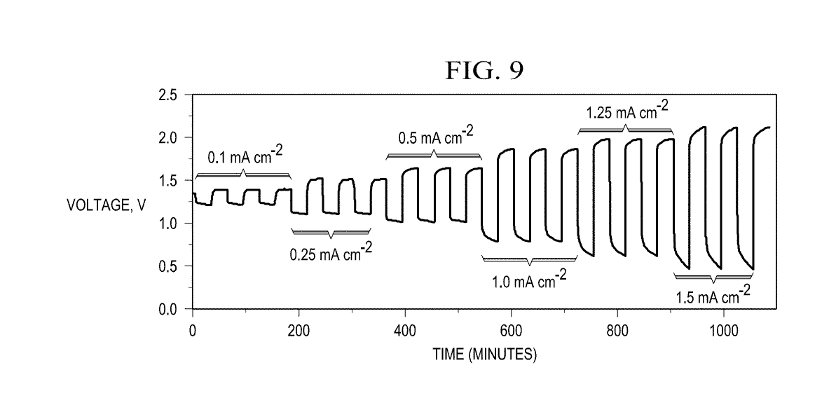

Further details of specific Fe-ferrocyanide batteries are provided in the Example 3 and in FIG. 9. Further details of specific Zn-ferrocyanide batteries, in which Zn is used in place of Fe, are provided in Example 2 and FIG. 7.

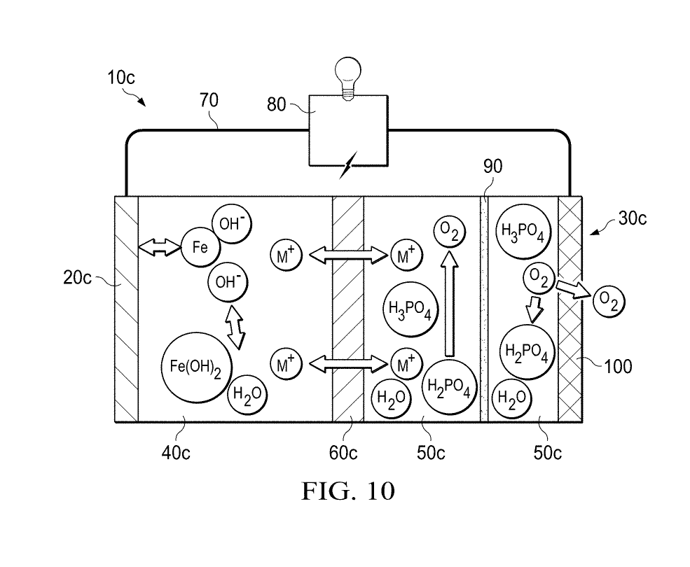

FIG. 10 presents a specific battery, Fe-airbattery 10c. Anode 20c includes metallic iron (Fe), which may be present as metal alone or in a composite matrix with electrically conductive carbon. Anolyte 40c includes an aqueous solution of alkali metal hydroxide, such as lithium hydroxide (LiOH) or sodium hydroxide (NaOH). Cathode 30c includes OER 90 and ORR 100. Catholyte 50c includes H₃PO₄/MH₂PO₄, wherein M is an alkali metal. The same alkali metal ion is the mediator-ion and is used in anolyte 40c, catholyte 50c, and mediator-ion solid state electrolyte 60c. The solid state electrolyte is either NSP, NZSP, or LATP. Catholyte 50c may include other acids, including inorganic and organic acids, such as HCl, H₂SO₄, HNO₃, HClO₄, CH₃COOH, and C₃H₄O₄, may also be used. Catholyte 50c may include mixtures of different compositions, such as H₃PO₄ lithium dihydrogen phosphate (LiH₂PO₄). Because catholyte 50c is acidic, it prevents CO₂ ingression from the air, which is a problem associated with alkaline electrolytes.

More particularly, during discharge, iron in the metallic iron anode 20c is first oxidized by losing two electrons to the external circuit 70 to create an iron cation (Fe²⁺) that reacts with negatively charged hydroxide (OHF) ions to form soluble Fe(OH)₂. At cathode 30c during discharge, the catholyte 50c accepts an electron provided by external circuit 70 and OER 90 catalyzes the formation of H₃PO₄ and the release of O₂ and M⁺ from MH₂PO₄. To maintain charge balance between the anolyte 40c and catholyte 50c, the lithium ion or sodium ion, migrates through the NSP, NZSP, or LATP solid state electrolyte 60c.

During charge, Fe(OH)₂ in anolyte 40c accepts electrons from the external circuit 70 and is reduced into metallic iron, which plates onto anode 20c and hydroxide ions, which remain in anolyte 40c. The hydroxide ions associate with lithium ion or sodium ion in the solution and form lithium hydroxide or sodium hydroxide. At cathode 30c during charge, the catholyte 50c release an electron to external circuit 70 and OPR 100 catalyzes the formation of MH₂PO₄ from H₃PO₄, O₂ and M⁺. To maintain charge balance between the anolyte 40c and catholyte 50c, the lithium ion or sodium ion migrates the opposite way through the NSP, NZSP, or LATP solid state electrolyte 60c.

OER 90 contains an OER catalyst, which is typically different than the ORR catalyst, found in ORR 100. Cathode 30c is a decoupled air cathode, containing a separate ORR 100 and OER 90, because the active sites for the ORR and the OER and the electrochemical environment in which the reactions occur are so different that it is very difficult to achieve high activity for both reactions within one material. For example, the ORR typically uses hydrophobic sites, which form a three-phase (solid catalyst, liquid electrolyte, and air) interface. In contrast, the OER typically uses hydrophilic sites to maximize the contact between the catalyst and the electrolyte. By dividing the OER and ORR functions into two different physical components 90 and 100 of the decoupled air cathode 30c, which may be two different electrodes, the two different physical components 90 and 100 may be optimized for OER and ORR respectively. This allows high battery efficiency as well as long cycle life. Alternative air cathode designs, with or without a separate ORR and OER may also be used, but the configuration of FIG. 10 may be particularly well suited for use with an acidic catholyte 50c.

OER 90 may include any OER catalyst able to evolve oxygen from catholyte 50c into the air. The exact identity of the OER catalyst as well as the location of OER 90 in battery 10c may depend somewhat on what constitutes catholyte 50c. For instance, the OER catalyst may have a set stability, activity, or both in a solution with the catholyte's acidity. Any support, particularly conductive supports, may have less than a set chemical reactivity with catholyte 50c and may have a set stability at the catholyte's acidity. Any support may also have low or no OER activity, particularly as compared to the OER catalyst. Example OER catalysts include iridium oxide (IrO₂), which may be in the form or a thin film grown on a titanium (Ti) mesh (IrO₂/Ti). Other materials like MnOₓ, PbO₂, and their derivatives are also suitable OER catalysts. Other OER catalysts may be free-standing, or on different conductive supports, such as other metal meshes. The OER catalyst may be present in small particles, such as particles less than 100 nm, less than 50 nm, or less than 20 nm in average diameter. In order to present a high number of active sites to the catholyte, the OER catalyst may be amorphous. OER 90 may be carbon-free and binder-free, ensuring good mechanical integrity in battery 10c.

ORR 100 may include any ORR catalyst able to reduce oxygen in the air so that it may react with catholyte 50c. The exact identity of the ORR catalyst as well as the location of ORR 100 may depend somewhat on what constitutes catholyte 50c. Example ORR catalysts include a noble-metal-based catalyst, such as platinum (Pt), palladium (Pd), silver (Ag), and their alloys or non-noble-metal-based catalysts such as cobalt-polypyrrole (Co-PPY-C), iron/nitrogen/carbon(Fe/N/C), or pure carbon with hetero-atom dopants, such as nitrogen (N)-doped graphene, carbon nanotube, or mesoporous carbon. Because it is decoupled from OER 90, ORR 100 may be isolated during a high-voltage charge process, minimizing catalyst dissolution and oxidation.

In order to allow access to air, at least a portion of decoupled air cathode 30c, such as at least ORR 100 may be porous. OER 90 may also be porous.

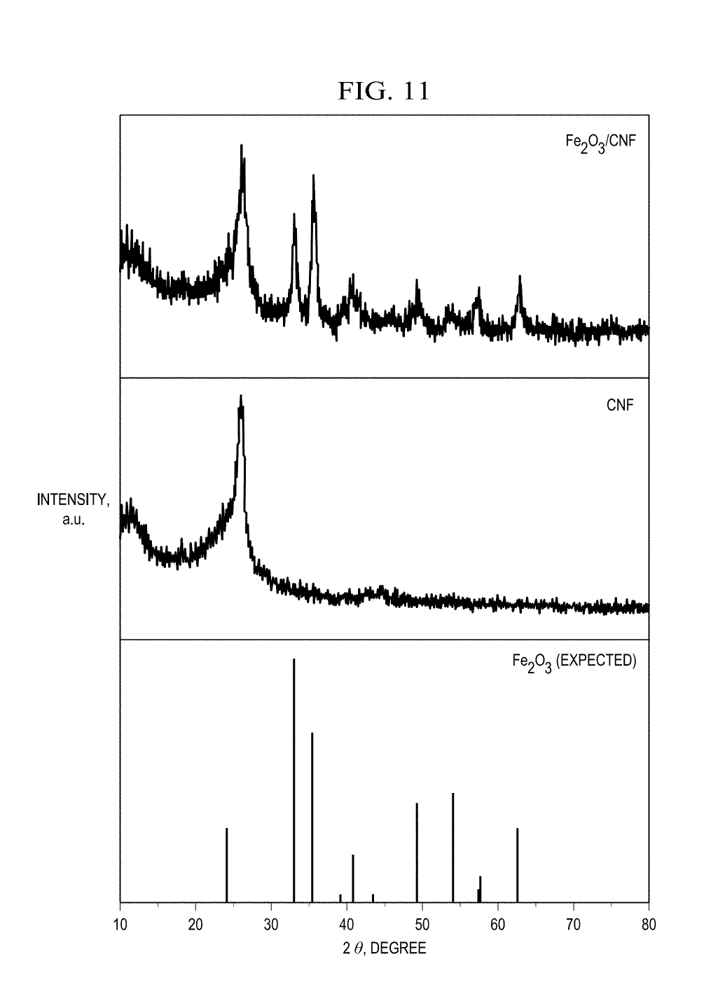

Further details of specific Fe-air batteries are provided in the Example 4 and in FIGS. 11-21.

FIG. 22 presents a specific battery, Zn-metal acid battery 10d. Anode 20d includes metallic zinc (Zn), which may be present as metal alone or in a composite matrix with electrically conductive carbon. Cathode 30d includes a current collector. Anolyte 40d includes an aqueous alkaline solution of alkali metal hydroxide, such as lithium hydroxide (LiOH) or sodium hydroxide (NaOH). Catholyte 50d includes an aqueous solution of a metal other than the metal of anode 20d or the alkali metal as well as an acid. Catholyte 50d is able to accept an alkali metal ion, however. The same alkali metal ion is the mediator-ion and is used in anolyte 40d, catholyte 50d, and mediator-ion solid state electrolyte 60d. The metal in catholyte 50d may be any metal able to exist in multiple oxidation states. In particular, it may be cerium (Ce). The acid in catholyte 50d may be any acid that does not cause degradation of the metal. In particular, it may be methane sulfonic acid (MSA). Use of an alkaline anolyte 40d and an acidic catholyte 50d enhances the operating voltage of battery 10d. The solid state electrolyte is either NSP, NZSP, or LATP.

More particularly, during discharge, zinc in the metallic zinc anode 20d is first oxidized by losing two electrons to the external circuit 70 to create a zinc cation (Zn²⁺) that reacts with negatively charged hydroxide (OHF) ions to form soluble zincate ions. The zincate has a tendency to dissociate into insoluble zinc oxide and water upon being saturated in an aqueous solution. At cathode 30d during discharge, the catholyte 50d accepts an electron provided by external circuit 70 and the cerium is reduced from Ce⁴⁺ to Ce³⁺. To maintain charge balance between the anolyte 40d and catholyte 50d, the lithium ion or sodium ion, migrates through the NSP, NZSP, or LATP solid state electrolyte 60d.

During charge, zincate in anolyte 40d accepts electrons from the external circuit 70 and is reduced into metallic zinc, which plates onto anode 20d, and hydroxide ions, which remain in anolyte 40d. The hydroxide ions associate with lithium ion or sodium ion in the solution and form lithium hydroxide or sodium hydroxide. The cerium in catholyte 50d is oxidized from Ce³⁺ to Ce^{4+.} To maintain charge balance between the anolyte 40d and catholyte 50d, the lithium ion or sodium ion migrates the opposite way through the NSP, NZSP, or LATP solid state electrolyte 60d.

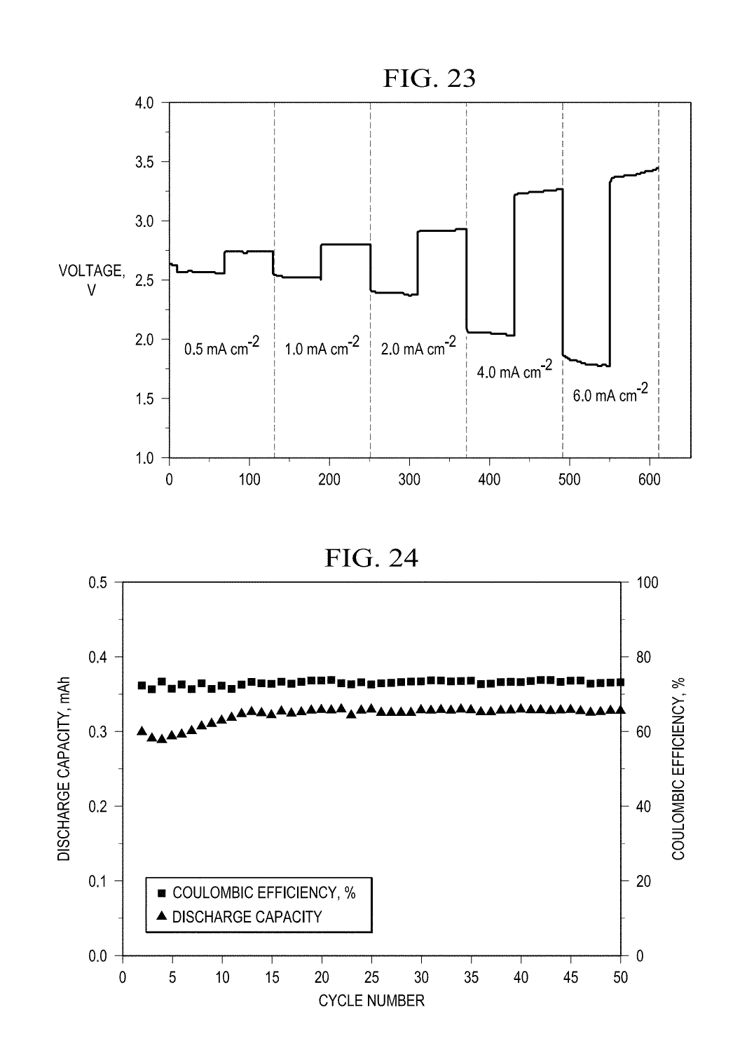

Further details of specific Zn-metal acid batteries are provided in the Example 5 and in FIGS. 23 and 24.

A battery according to the present disclosure, particularly a Zn—Br₂ battery, a Zn-ferrocyanide battery, a Fe-ferrocyanide battery, a Zn-air battery, a Fe-air battery, a Zn-metal acid battery, or a Fe-metal acid battery may have of the following features alone or in combination:
The mediator-ion solid state electrolyte may have an ionic conductivity for the mediator-ion of at least 0.5×10⁻⁴ S/cm, at least 1×10⁻⁴ S/cm, at least 2×10⁻⁴ S/cm, at least 3×10⁻⁴ S/cm, or at least 3.4×10⁻⁴ S/cm.
The battery may utilize at least 90%, at least 95%, or at least 98% of the cathode active material, as calculated by comparing actual capacity to theoretical capacity.
After discharge to 89% of its theoretical capacity, 20% or less, 15% or less, or 10% or less of cathode active material may remain in the catholyte.
After discharge to a cutoff voltage of 45% of its OCR, 5% or less, 2% or less, or 1% or less of the cathode active material may remain in the catholyte.
When in a substantially flat configuration, the battery may have a power density of at least 10 mW/cm², at least 12 mW/cm², or at least 14 mW/cm².
When in a substantially flat configuration, the battery may have a current density of at least 8 mA/cm², at least 9 mA/cm², or at least 10 mA/cm².

A rechargeable battery as disclosed herein may be in traditional form, such as a coin cell or jelly roll, or a more complex cell such as a prismatic cell. It may include a single electrochemical cell or multiple cells. Batteries with more than one cell may contain components to connect or regulate these multiple electrochemical cells.

In the case of more sophisticated batteries, they may contain more complex components, such as safety devices to prevent hazards if the battery overheats, ruptures, or short circuits. Particularly complex batteries may also contain electronics, storage media, processors, software encoded on computer readable media, and other complex regulatory components.

Rechargeable batteries of the present disclosure may be used in a variety of applications. They may be in the form of standard battery size formats usable by a consumer interchangeably in a variety of devices. They may be in power packs, for instance for tools and appliances. They may be usable in consumer electronics including cameras, cell phones, gaming devices, or laptop computers. They may also be usable in much larger devices, such as electric automobiles, motorcycles, buses, delivery trucks, trains, or boats. Furthermore, batteries according to the present disclosure may have industrial uses, such as energy storage in connection with energy production, for instance in a smart grid, or in energy storage for factories or health care facilities, for example in the place of generators.

Voltages herein are given versus a standard hydrogen electrode.

### EXAMPLES

The present invention may be better understood through reference to the following examples. These examples are included to describe exemplary embodiments only and should not be interpreted to encompass the entire breadth of the invention.

### Example 1: Preparation and Characterization of a Zn—Br₂ Battery with a Hydroxide Catholyte

Two Zn—Br₂ batteries as shown in FIG. 2, one with a Na⁺ mediator-ion solid state electrolyte (a Zn(NaOH)∥Na-SSE∥Br₂ (NaBr) cell) and one with a Li⁺ mediator-ion solid state electrolyte (a Zn(LiOH)∥Li-SSE∥Br₂ (LiBr) cell) were prepared. The solid state electrolyte for the Na⁺ mediator-ion was NSP and the solid state electrolyte for the Li⁺ mediator-ion was LATP. In both instances, it provided ion channels to transport the mediator-ion between the anode side of the battery and the cathode side of the battery.

The Zn—Br₂ batteries were assembled and tested in a layered battery format. The anode was formed by attaching a Zn metal plate to a titanium wire external circuit. The cathode was formed by attaching a carbon paper matrix (Toray, Japan) to a titanium wire external circuit.

For the Zn(NaOH)∥Na-SSE∥Br₂ (NaBr) cell, the anolyte and the catholyte were, respectively, 0.5 M NaOH aqueous solution and 0.5 M NaBr+0.1 M Br₂ aqueous solution.

For the Zn(LiOH)∥Li-SSE∥Br₂ (LiBr) cell, the anolyte and the catholyte were, re-spectively, 0.5 M LiOH aqueous solution and 0.5 M LiBr+0.1 M Br₂ aqueous solution.

The NSP solid state electrolyte was prepared by a solid-state reaction, followed by a spark plasma sintering (SPS) process. In particular the NSP solid state electrolyte was prepared by a sequence of solid-state reactions of stoichiometric mixtures of Na₂CO₃, Sc₂O₃, (NH₄)₂H(PO₄)₃, and SiO₂. The mixtures were ground together for 1 h in an agate mortar and heated first at 450° C. for 1.5 h and then at 900° C. for 24 h in air with a heating rate of 3° C./min from 450° C. to 900° C. The heated mixture was then ball-milled for 8 h, pressed into pellets in a graphite die, and sintered by a SPS process at 1200° C. for 10 min with a heating rate of 80° C./min under a pressure of 50 MPa.

The LATP solid state electrolyte was purchased from Ohara Corporation (Japan) (Na+-ion conductivity of 1×10⁻⁴ S/cm).

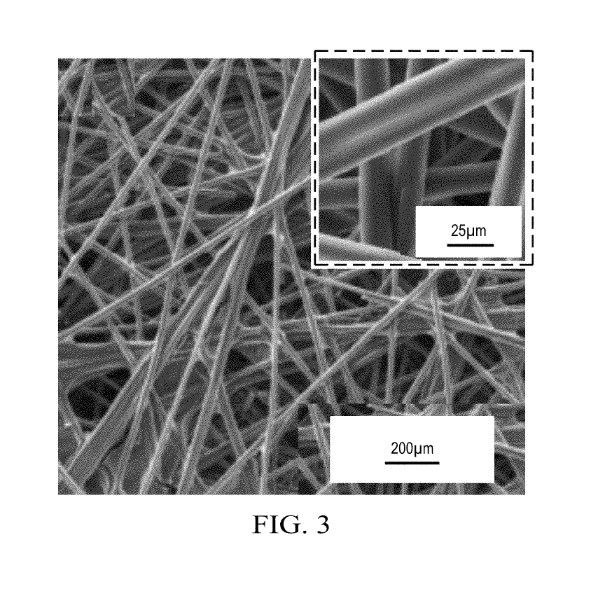

The morphologies of the cathode carbon paper matrix and the NSP solid state electrolyte were studied with a Quanta 650 SEM. The fibrous structure of the cathode carbon paper is evident in FIG. 3, in which the diameter of the carbon fiber is observed to be about 5-10 μm, and the interspace between the woven fibers about 10-50 μm. The carbon fiber acted as the current collector to support the electrochemical reactions of the Br₂ cathode. The Br₂ cathode active material, discharge products, and the anolyte were accommodated by the interspace between the fibers. The interwoven fibers provides structural integrity to the matrix.

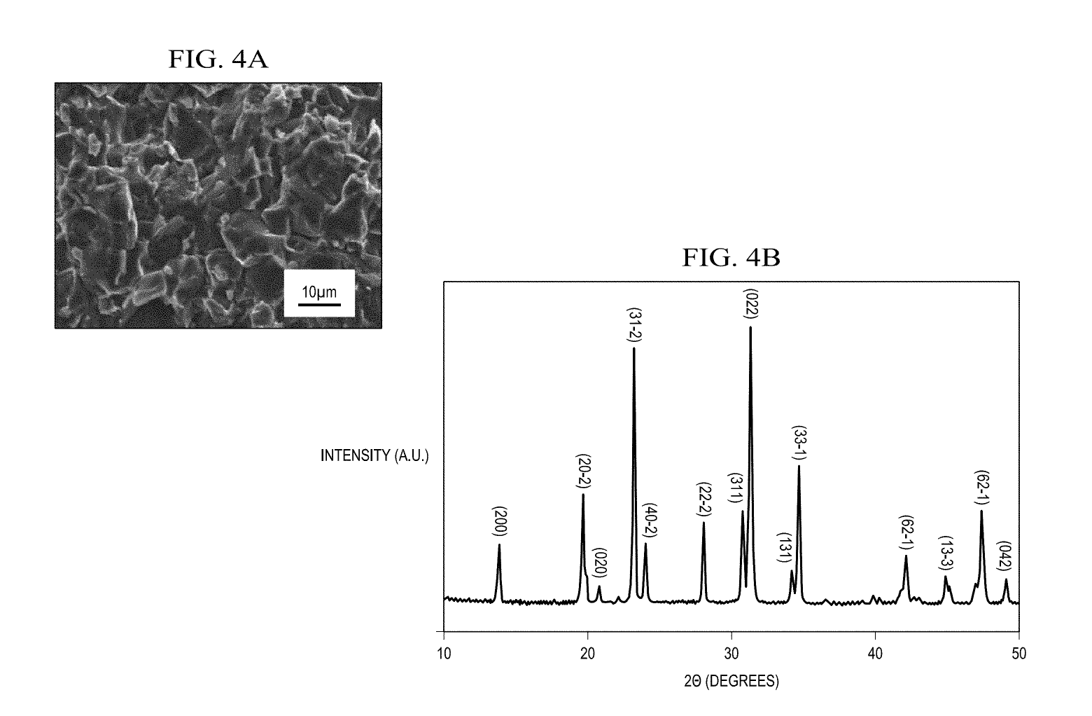

As shown in FIG. 4, Part (a), the NSP solid state electrolyte had a dense structure. The relative density was 98% of its theoretical value. An XRD pattern of the NSP solid state electrolyte was obtained with a Rigaku X-ray diffractometer equipped with CuK radiation at a scan rate of 0.5°/min and a scan step of 0.02°. The XDR pattern with planes for each reflection indicated is presented in FIG. 4, Part (b). Conductivity of the NSP solid state electrolyte was measured via EIS which was carried out with a computer-controlled Solartron 1260 impedance/gain-phase analyzer with a frequency range from 0.1 Hz to 1 MHz. Both sides of the NSP layer were sputtered with a thin layer of gold. The conductivity of the NSP solid state electrolyte was 3.4×10⁻⁴ S/cm.

Charge-discharge curves as well as the polarization behavior of the Zn— Br₂ cells were recorded with an Arbin BT 2000 battery cycler. FIG. 5, Part (a) shows a representative discharge profile of the Zn(NaOH)∥Na-SSE∥Br₂ (NaBr). A specific discharge capacity of 330 mAh/g was obtained. In comparison to the theoretical capacity of Br₂ (338 mAh/g, based on the electrochemical reaction of Br₂+2e−→2Br−), utilization of the bromine cathode active material was 98%. To confirm the depth of discharge of the cathode, the concentration of bromine in the catholyte was analyzed with UV-Vis carried out on a Varian Cary 5000 UV-Vis-NIR Spectrophotometer. The UV-Vis results are presented in FIG. 5, Part (b). In a Br₂/NaBr aqueous solution, Br₂ exists as tribromide ion (Br³), which has a characteristic absorption peak at the wavelength of 266 nm. After discharging the cathode to a specific capacity of 300 mAh/g, 10% bromine was left in the catholyte in comparison to its original concentration, as determined by UV-Vis. When the battery was discharged to a cutoff voltage of 1.2 V, only 1% of the bromine was left in the catholyte. The high utilization of the active bromine indicates that the carbon paper matrix facilitated the redox reaction at the cathode and offers sufficiently accommodated the bromine cathode active material and the discharge products in its interspaces.

Polarization behavior of the Zn(NaOH)∥Na-SSE∥Br₂ (NaBr) cell and the Zn(LiOH)∥Li-SSE∥Br₂ (LiBr) cell was also studied. The OCVs of the two cells were almost identical at 2.2-2.3 V. Upon the application of discharge and charge currents, the voltage responses of the two cells were recorded. As seen in FIG. 6, Parts (a) and (b), with increasing current density, the discharge voltages decreased and the charge voltages increased for both the Zn(NaOH)∥Na-SSE∥Br₂ (NaBr) and the Zn(LiOH)∥Li-SSE∥Br₂ (LiBr) cells. However, the polarization of the Zn(NaOH)∥Na-SSE∥Br₂ (NaBr) cell is relatively less significant compared to that of the Zn(LiOH)∥Li-SSE∥Br₂ (LiBr) cell. Discharge voltages and power densities versus the applied current density for the two cells are presented in FIG. 6, Part (c). At ambient temperature, the Zn(NaOH)∥Na-SSE∥Br₂ (NaBr) delivered a power density of 14.0 mW/cm² at a current density of 10.0 mA/cm².

Compared to the Zn(NaOH)∥Na-SSE∥Br₂ (NaBr) cell, the relatively higher polarization behavior of the Zn(LiOH)∥Li-SSE∥Br₂ (LiBr) cell was attributed primarily to the relatively lower ionic conductivity of LATP (1×10⁻⁴ S/cm) as compared to NSP (3.4×10⁻⁴ S/cm) and the lower dissociation behavior of LiOH in aqueous solution.

FIG. 6, Part (d) shows EIS results for the Zn(NaOH)∥Na-SSE∥Br₂ (NaBr) and the Zn(LiOH)∥Li-SSE∥Br₂ (LiBr) cells. Both the bulk impedance (RL) and the charge transfer impedance (Rct) of the Zn(LiOH)∥Li-SSE∥Br₂ (LiBr) cell were relatively higher than those of the Zn(NaOH)∥Na-SSE∥Br₂ (NaBr) cell.

### Example 2: Preparation and Characterization of a Zn-Ferrocyanide Battery with a Ferrocyanide Catholyte

To demonstrate the ability of batteries of the present disclosure to use a variety of cathode active materials, Zn-ferrocyanide (K₄Fe(CN)₆) batteries with either a LATP or NSP solid state electrolyte was formed. The batteries also demonstrated that the catholyte and anolyte may share more chemical components other than the mediator-ion (in this case LiOH, or NaOH was shared).

The Zn(LiOH)∥Li-SSE∥LiOH/(K₄Fe(CN)₆) cell was prepared with a 0.5 M LiOH anolyte and a mixture of 0.4 M K₄[Fe(CN)₆]+0.5 M LiOH as the catholyte. The Zn(LiOH)∥Na-SSE∥NaOH/(K₄Fe(CN)₆) cell with the Na+-ion solid state electrolyte was prepared with a 0.5 M NaOH anode electrolyte and a mixture of 0.4 M K₄[Fe(CN)₆]+0.5 M NaOH as the catholyte. Polarization behavior of the two cells is provided in FIG. 7.

### Example 3: Preparation and Characterization of a Fe-Ferrocyanide Battery with a Ferrocyanide Catholyte

A Fe-ferrocyanide battery as shown in FIG. 8, deemed a Fe(NaOH)∥Na-SSE∥K₃Fe(CN)₆(NaOH) battery, was prepared in a manner similar to the Zn-battery in Example 2. The overall expected open circuit voltage of the battery is 1.39 V. FIG. 9 shows the voltage profile of the Fe(NaOH)∥Na-SSE∥K₃Fe(CN)₆(NaOH) battery operated under various current densities. In comparison to the Zn-anode battery of Example 2, the Fe(NaOH)∥Na-SSE∥K3Fe(CN)6(NaOH) cell shows significantly larger polarization, most likely due to the relatively sluggish electrode reaction of Fe.

### Example 4: Preparation and Characterization of a Fe-Air Battery

Two Fe-air batteries as shown in FIG. 10, one with a Na⁺ mediator-ion solid state electrolyte (a Fe(NaOH)∥Na-SSE∥O₂(H₃PO₄/NaH₂PO₄ battery) and one with a Li⁺ mediator-ion solid state electrolyte (Fe(LiOH)∥Li-SSE∥O₂(H₃PO₄/LiH₂PO₄ battery) were prepared.

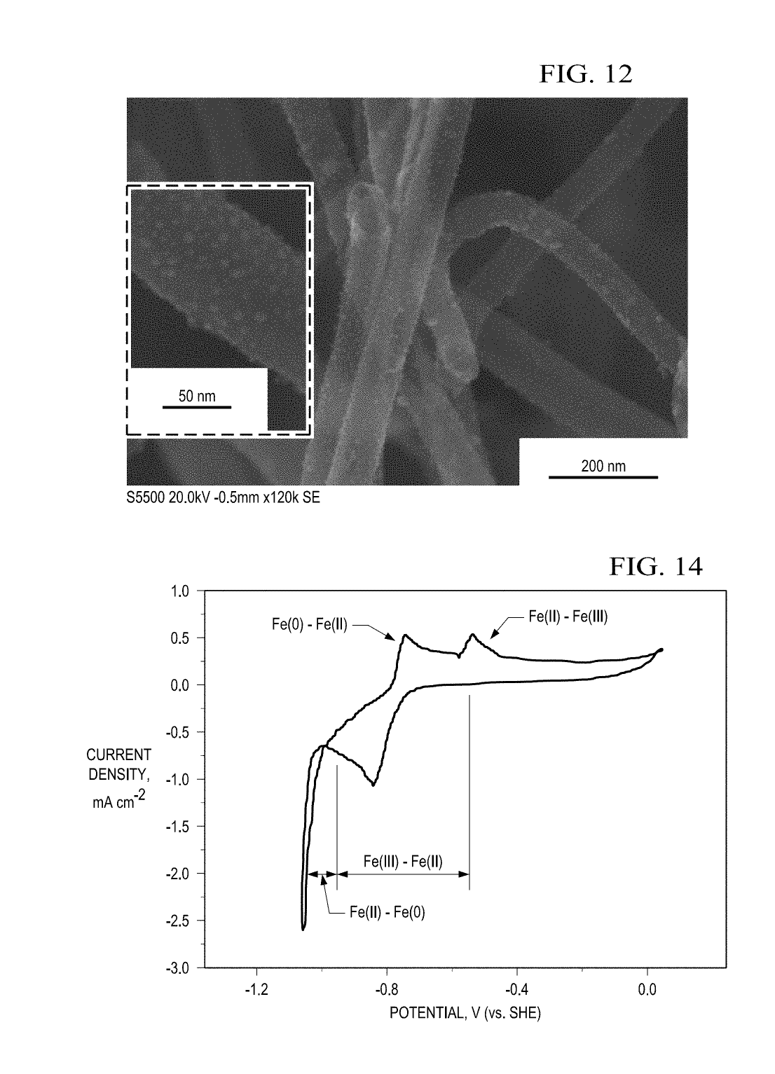

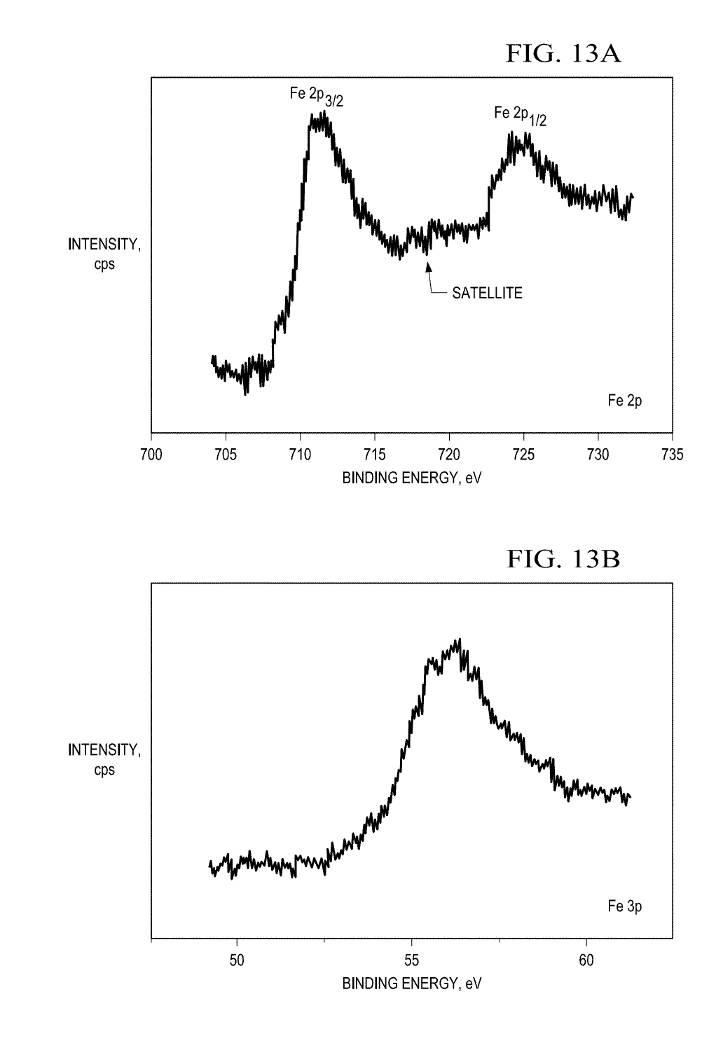

The anodes were synthesized carbon nanofiber (CNF) supported iron oxide (Fe₂O₃/CNF). The XRD pattern of the Fe₂O₃/CNF (FIG. 11, upper panel) clearly indicated the presence of Fe₂O₃ on the CNF when compared to the XRD pattern of the pristine CNF (FIG. 11, middle panel) and the expected XRD pattern of Fe₂O₃ (FIG. 11, bottom panel). SEM analysis (FIG. 12) of the Fe₂O₃/CNF showed that the Fe₂O₃ particles were homogeneously dispersed on the CNF. The size of the Fe₂O₃ particles was approximately 2-10 nm. Such a structure ensures a facile cyclability of the Fe₂O₃/CNF electrode. The Fe₂O₃/CNF was also characterized with XPS. The Fe 2p XPS spectrum in FIG. 13A shows the typical characteristics of Fe₂O₃ with three typical peaks of Fe 2p3/2 (at 710.6-711.2 eV), Fe 2p1/2 (at 724.6-725.2 eV), and a satellite peak at 718.8 eV. The Fe 3p XPS spectrum in FIG. 13B exhibits a single peak with an overlapped Fe 3p3/2/Fe 3p1/2 peak at 55.6 eV, corresponding to the characteristic peak of Fe³⁺ peak in iron oxide.

FIG. 14 is a cyclic voltammogram of the Fe₂O₃/CNF electrode in a 0.5 M NaOH solution. The two oxidation peaks around −0.70 V and −0.50 V are, attributed to the oxidation reactions of Fe→Fe²⁺ and Fe²⁺→Fe³⁺. In the cathodic process, the reduction peak around −0.81 V corresponds to the reduction of Fe³⁺→Fe²⁺. The reduction peak for the reaction of Fe²⁺→Fe is not visible in FIG. 14, likely because it is overlapped with the hydrogen evolution peak occurring around −1.00 V.

The SSE two types of solid electrolytes employed here are, respectively, LATP, and Na₃Zr₂Si₂PO₁₂ (NZSP) (421 Energy Corporation, South Korea, with a Na+-ion conductivity of approximately 1.0×10 S/cm at room temperature). The LATP and NZSP did not act as a direct Fe²⁺-ion conductive media, but provided ionic channels for transporting the mediator Li+-ion or Na+-ion to facilitate charge balance between the anode and cathode sides of the cell during the charge-discharge processes.

Both batteries contained an acidic catholyte, providing a higher positive potential and a theoretical voltage of around 2.11 V. The catholytes contained a H₃PO₄ solution with either LiH₂PO₄ or NaH₂PO₄ as a supporting electrolyte.

The decoupled bifunctional air cathodes contained a titanium mesh supported iridium oxide (IrO₂/Ti) electrode as the OER and a carbon-supported platinum (Pt/C) electrode as the ORR.

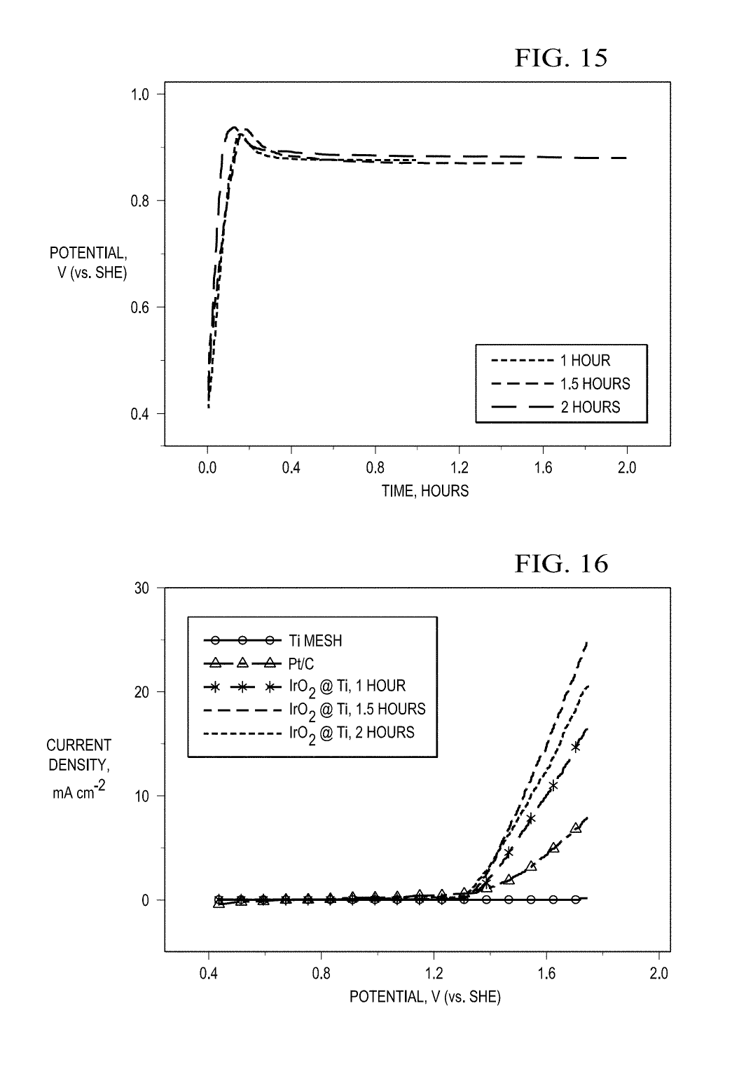

The loadings of the IrO₂ on Ti mesh were estimated to be approximately 0.18 mg/cm² (1 h deposition), approximately 0.27 mg/cm² (1.5 h deposition), and approximately 0.36 mg/cm² (2 h deposition) according to our previous report. However, the influence of the deposition time on the OER activity of the IrO₂/Ti electrode was also evaluated. The IrO₂ was deposited electrochemicallyusing a 3-electrode cell. Upon applying a constant current to the Ti mesh, the potential of the electrode quickly reaches a stable value at about 0.89 V (FIG. 15). FIG. 16 shows the OER activity of the obtained IrO2/Ti electrodes, evaluated with a linear sweep voltammetry method. As seen in FIG. 16, the Ti mesh did not provide any OER activity, showing almost no anodic current within the testing potential range (approximately 0.4 V-1.8 V). However, the anodic currents of the IrO₂/Ti electrodes increased sharply after approximately 1.30 V, showing a significant OER activity. A Pt/C electrode was also included as a comparison. All the IrO₂/Ti electrodes showed significantly higher OER catalytic activity than Pt/C, suggesting that the IrO₂/Ti is an efficient OER catalyst. The IrO₂ deposition time had a significant impact on the OER activity of the IrO₂/Ti electrodes. Increasing the deposition time from 1.0 h to 1.5 h increased the current density from approximately 15 mA/cm² 2 to approximately 25 mA/cm² at approximately 1.8 V. However, a further increase in the deposition time (e.g., to 2.0 h) did not improve the OER activity any more, revealing that 1.5 h deposition was sufficient to achieve a highly active IrO₂/Ti electrode for OER.

Electrochemical stability of the IrO₂/Ti electrode in the H₃PO₄/NaH₂PO₄ solution was evaluated by applying a constant current density to the electrode. FIG. 17 displays the chronopotentiometry profile at a current density of 1.0 mA/cm². The charge potential of the IrO₂/Ti electrode quickly jumped to approximately 1.65 V upon applying the current. After a continuous slow decrease, the potential of the electrode was stabilized at approximately 1.50-1.52 V. There was no obvious potential degradation observed after 15 days. The high OER activity and the high durability demonstrates that IrO₂/Ti is a favorable catalyst for the operation of Fe-air batteries.

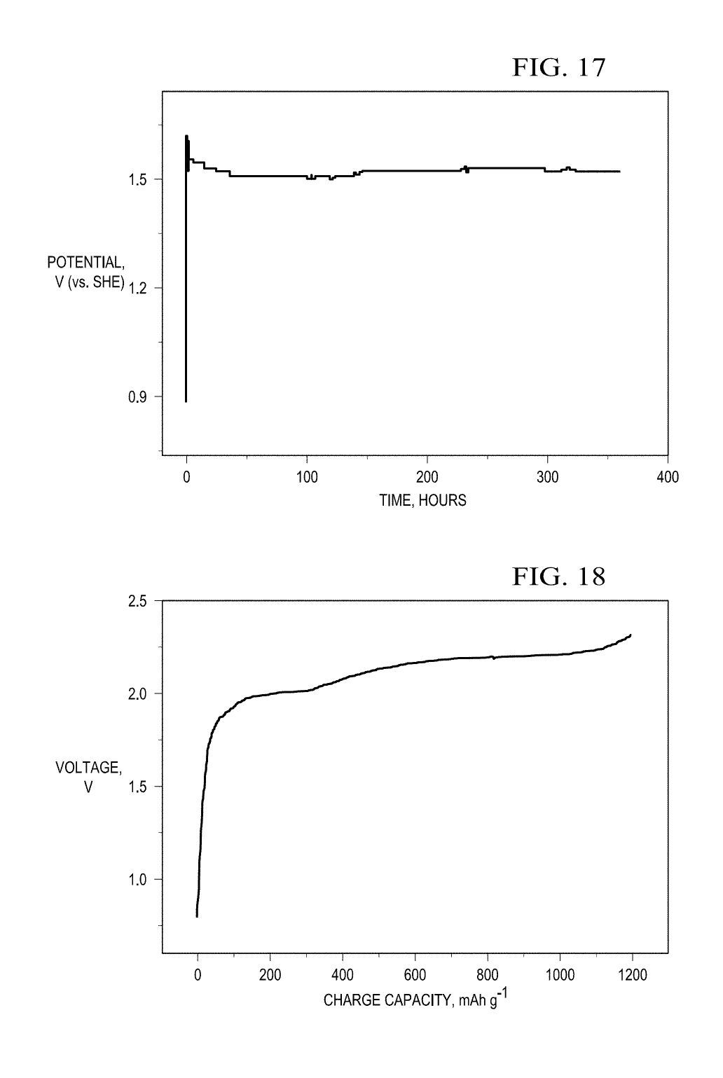

The Fe-air batteries had to first be charged before further evaluations were possible, due to the Fe₂O₃/CNF anode. FIG. 18 shows the first charge curve of the Fe(NaOH)∥Na-SSE∥O₂(H₃PO₄/NaH₂PO₄ battery prepared with the Fe₂O₃/CNF anode. With the IrO₂/Ti OER cathode, the first charge profile shows a two-plateau feature. According to the information in the literature, the first charge plateau at approximately 1.95 V corresponds to the reaction of Fe³⁺ to Fe²⁺. The second charge plateau at approximately 2.12 V is attributed to the reduction reaction of Fe²⁺ to Fe. A specific charge capacity of approximately 1200 mAh/g (based on Fe₂O₃) was obtained during the first charge. This capacity is a little higher than the theoretical capacity of the Fe₂O₃ electrode (1005 mAh/g). The extra charge capacity is assumed to be contributed from the hydrogen evolution reaction. After the first charge, the cell was connected to an LED and the LED lighted. Voltage profiles of a full discharge-charge cycle for the Fe(NaOH)∥Na-SSE∥O₂(H₃PO₄/NaH₂PO₄ battery exhibited a two-voltage-plateau characteristic due to the step-reduction or the step-oxidation reactions of the Fe-anode. Accordingly, the battery was functional.

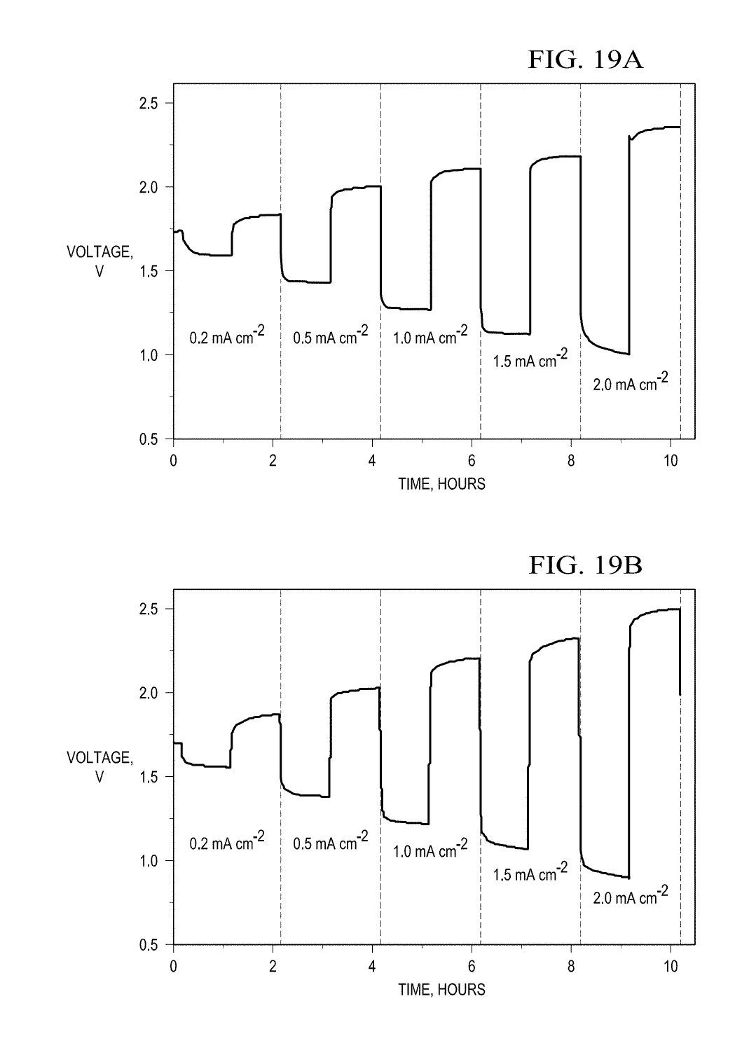

FIGS. 19A and 19B present the polarization behavior of Fe(NaOH)∥Na-SSE∥O₂(H₃PO₄/NaH₂PO₄ battery and the Fe(LiOH)∥Li-SSE∥O₂(H₃PO₄/LiH₂PO₄ battery, respectively. After the first charge, the open circuit voltages (OCV) of the two cells were almost identical at approximately 1.7-1.8 V. Upon the application of discharge and charge currents, the voltage responses of the two cells were recorded. The current densities tested were selected on the basis of the current densities suitable for use with the SSEs. Both the ionic conductivity and the thickness of the SSE used for the tests of the Fe-air batteries were not optimized. Therefore, it limited the current density that could be applied. If the conductivity of the SSE is improved and the thickness of the membrane is reduced, similar batteries would be able to sustain high current densities.

As seen in FIGS. 19A and 19B, with increasing current density, the discharge voltages decreased and the charge voltages increased for both the batteries. However, the polarization of the Fe(NaOH)∥Na-SSE∥O₂(H₃PO₄/NaH₂PO₄ battery was relatively less significant compared to that of the Fe(LiOH)∥Li-SSE∥O₂(H₃PO₄/LiH₂PO₄ battery. The relatively higher polarization behavior of the Fe(LiOH)∥Li-SSE∥O₂(H₃PO₄/LiH₂PO₄ battery is attributable mainly to the relatively lower conductivity of LATP (1.0×10⁻⁴ S/cm) as compared to that of the NZSP (1.0×10⁻³ S/cm) and the lower dissociation behavior of LiOH in aqueous solution.

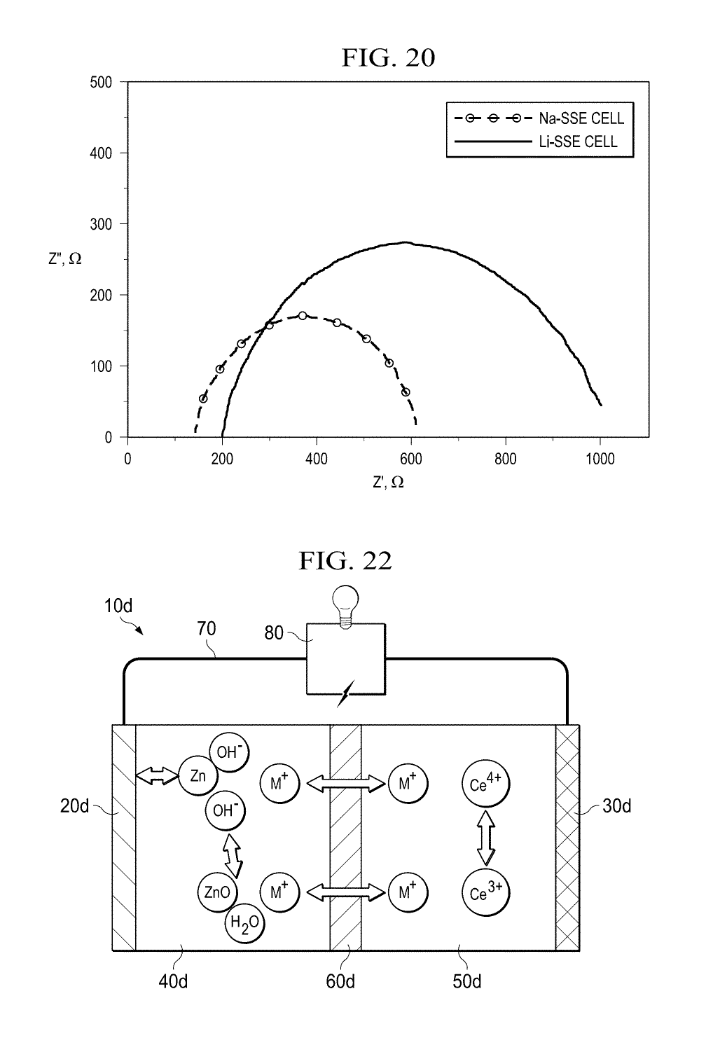

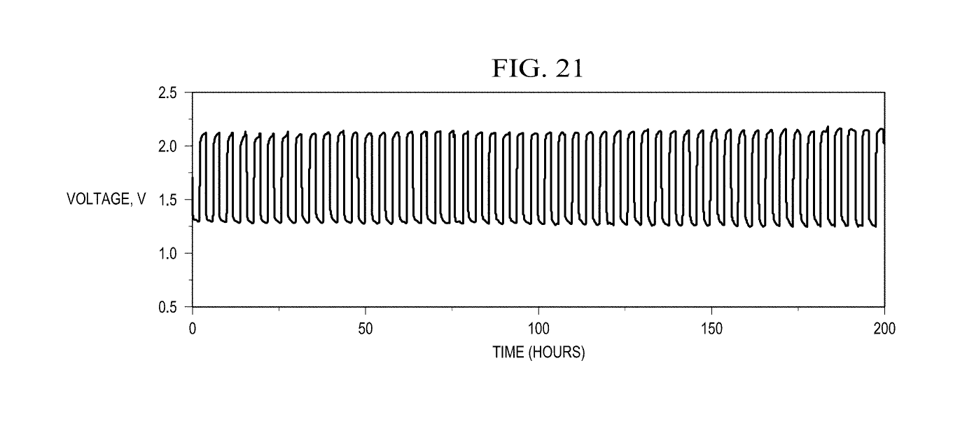

FIG. 20 shows the EIS results obtained for the Fe(NaOH)∥Na-SSE∥O₂(H₃PO₄/NaH₂PO₄ battery and the Fe(LiOH)∥Li-SSE∥O₂(H₃PO₄/LiH₂PO₄ battery. According to the equivalent circuit and the Nyquist plot shown in FIG. 20, both the bulk impedance (RL) and the charge transfer impedance (Rct) of Fe(LiOH)∥Li-SSE∥O₂(H₃PO₄/LiH₂PO₄ battery were relatively higher than those of the Fe(NaOH)∥Na-SSE∥O₂(H₃PO₄/NaH₂PO₄ battery. FIG. 21 presents the long-term cycling performance of the Fe(NaOH)∥Na-SSE∥O₂(H₃PO₄/NaH₂PO₄ battery at a constant current density of 1.0 mA/cm². There was no significant voltage degradation and capacity loss throughout 50 cycles, indicating no liquid electrolyte crossover through the NZSP.

### Example 5: Preparation and Characterization of a Zn-Metal Acid Battery

A Zn-metal acid battery as shown in FIG. 22, deemed a Zn(NaOH)∥Na-SSE∥Ce(VI)/MSA battery, was prepared in a manner similar to the batteries if Examples 1-3. The overall expected open circuit voltage of the battery is 2.64 V. FIG. 23 shows the voltage profile of the Zn(NaOH)∥Na-SSE∥Ce(VI)/MSA battery operated under various current densities. The battery exhibited useful polarization behavior. Data regarding long-term cycling performance of the Zn(NaOH)∥Na-SSE∥Ce(VI)/MSA) battery is provided in FIG. 24. Columbic efficacy of the battery is relatively low, but the discharge capacity is stable.

Although only exemplary embodiments of the invention are specifically described above, it will be appreciated that modifications and variations of these examples are possible without departing from the spirit and intended scope of the invention. For example, throughout the specification particular measurements are given. It would be understood by one of ordinary skill in the art that in many instances particularly outside of the examples other values similar to, but not exactly the same as the given measurements may be equivalent and may also be encompassed by the present invention.

1. An aqueous rechargeable battery comprising:
an anode comprising an anode active material;
a cathode comprising a cathode active material or an air cathode;
an anolyte comprising an alkali metal ion;
a catholyte comprising the same alkali metal ion or a metal acid catholyte; and
a mediator-ion solid state electrolyte with ion channels through with the alkali metal ion may pass as a mediator-ion,
wherein the mediator-ion solid state electrolyte prevents at least 99.9% of direct chemical reactions between the catholyte and the anolyte or anode active material and between the anolyte and cathode, and
wherein at least one of the anolyte and the catholyte is aqueous.

2. The battery of claim 1, wherein the anode active material comprises a metal-based active material.

3. The battery of claim 2, wherein the metal-based active material comprises elemental metal.

4. The battery of claim 1, wherein the metal-based anode active material comprises a metal compound.

5. The battery of claim 2, wherein the metal-based active material comprises a metal that is not an alkali metal.

6. The battery of claim 2, wherein the metal-based active material comprises zinc (Zn).

7. The battery of claim 2, wherein the metal-based active material comprises iron (Fe).

8. The battery of claim 2, wherein the metal-based active material comprises aluminum (Al) or magnesium (Mg).

9. The battery of claim 1, wherein the cathode comprises a liquid cathode active material and further comprises a current collector.

10. The battery of claim 1, wherein the cathode active material comprises any one or a combination of liquid bromine (Br₂), another halogen, ferrocyanide (K₄Fe(CN)₆), hydrogen peroxide, bromate, permanganate, nickel oxide, dichromate, iodate, a polysulfide and sulfur mixture, polysulfide, sulfur, manganese oxide, hypochlorite, perchlorate, copper, chlorate, manganese oxide, iron, copper, nickel oxide, perchlorate, nitrate, sodium bismuthate, tin, permanganate, chromate, tetramethoxy-p-benzoquinone, 2,6 dihydroxyanthraquinone, poly(aniline-co-m-aminophenol), polyaniline, poly(aniline-co-o-aminophenol), indigo carmine, indigo carmine, aminophenol, Ru-bipy, Ru-phen, Fe-bipy, Fe-phen, Ferroin, N-Phenylanthranilic acid, N-Ethoxychrysoidine, o-Dianisidine, Sodium diphenylamine sulfonate, Diphenylbenzidine, Diphenylamine, Viologen, Sodium 2,6-Dibromophenol-indophenol, Sodium o-Cresol indophenol, Thionine, Methylene blue, Indigotetrasulfonic acid, Indigotrisulfonic acid, Indigomono, Phenosafranin, Safranin T, Neutral red, ferrate, cuprous cyanide, metallocyanide, metal hydride, or quinone, or an oxygen/air cathode with an acid or base electrolyte.

11. The battery of claim 1, wherein the cathode comprises an air cathode comprising an oxygen evolution reaction (OER) and an oxygen reduction reaction (ORR) material.

12. The battery to claim 11, wherein the cathode further comprises an acidic catholyte.

13. The battery of claim 1, wherein the anolyte comprises a hydroxide of the alkali metal ion.

14. The battery of claim 1, wherein the catholyte comprises a hydroxide of the alkali metal ion.

15. The battery of claim 1, wherein the catholyte comprises a compound of the cathode active material and the alkali metal ion.

16. The battery of claim 1, wherein the catholyte comprise a metal acid catholyte.

17. The battery of claim 16, wherein the metal acid catholyte comprises cesium (Ce).

18. The battery of claim 16, wherein the metal acid catholyte comprises methane sulfone acid (MSA).

19. The battery of claim 1, wherein the alkali metal ion is sodium ion (Na⁺) and the mediator-ion solid state electrolyte is a Na⁺ solid state electrolyte.

20. The battery of claim 19, wherein the Na⁺ solid state electrolyte is Na_{3.4}Sc₂(PO₄)_{2.6}(SiO₄)_{0.4} (NSP).

21. The battery of claim 19, wherein the Na⁺ solid state electrolyte is Na₃Zr₂Si₂PO₁₂ (NZSP).

22. The battery of claim 1, wherein the alkali metal ion is lithium ion (Li⁺) and the mediator-ion solid state electrolyte is a Li⁺ solid state electrolyte.

23. The battery of claim 22, wherein the Li⁺ solid state electrolyte is Li_{1+x+y}AlₓTi₂₋ₓP_{3-y}Si_{y}O₁₂ (LATP).

24. The battery of claim 1, wherein the mediator-ion solid state electrolyte prevents all direct chemical reactions between the catholyte and the anolyte or anode active material and between the anolyte and cathode

25. The battery of claim 1, wherein the mediator-ion solid state electrolyte has an ionic conductivity for the mediator-ion of at least 0.5×10⁻⁴ S/cm.

126. The battery of claim 1, wherein the mediator-ion solid state electrolyte has an ionic conductivity for the mediator-ion of at least 3×10⁻⁴ S/cm.

27. The battery of claim 1, wherein the battery utilizes at least 90% of the cathode active material, as calculated by comparing actual capacity to theoretical capacity.

28. The battery of claim 1, wherein the cathode active material is a liquid located in the catholyte, and wherein after discharge of the battery to 89% of its theoretical capacity, 20% or less of cathode active material remains in the catholyte.

29. The battery of claim 1, wherein the cathode active material is a liquid located in the catholyte, and wherein, after discharge to a cutoff voltage of 45% of the battery's OCR, 5% or less of the cathode active material remains in the catholyte.

30. The battery of claim 1, wherein the battery has a substantially flat configuration and a power density of at least 10 mW/cm².

31. The battery of claim 1, wherein the battery has a substantially flat configuration and a current density of at least 8 mA/cm².
